(19) United States
(12) Patent Application Publication
(10) Pub. No.: US 2017/0173599 A1
(43) Pub. Date: Jun. 22, 2017

(54) Modular Nozzle Assembly and Fluidic Plate Apparatus and Method for Selectively Creating 2-D or 3-D Spray Patterns

(71) Applicant: dhBOWLES, Inc., Canton, OH (US)

(72) Inventors: Russell D. Hester, Odenton, MD (US); Steven Crockett, Hampstead, MD (US)

(73) Assignee: dlhBOWLES, Inc., Canton, OH (US)

(21) Appl. No.: 15/129,733

(22) PCT Filed: Mar. 27, 2015
(86) PCT No.: PCT/US15/22938

§ 371 Date: Sep. 27, 2016

Related U.S. Application Data
(60) Provisional application No. 61/971,078, filed on Mar. 27, 2014.

(51) Int. Cl. B05B 1/02; B05B 11/00; B05B 15/00

(52) U.S. Cl. CPC B05B 1/02; B05B 15/005; B05B 11/3011; B05B 11/3057; B05B 11/3045

(57) ABSTRACT

A modular nozzle assembly for use with standard trigger sprayers 1, 300 has components which replace the standard nozzle cap 24, 320. A user selectable and user changeable fluidic plate or fluidic circuit member 152, 372 is configured to allow the user to configure a particular combination of components to create precise 2-D or 3-D spray pattern when spraying or dispensing a liquid product from a trigger sprayer or aerosol sprayer. A spray kit with a user configurable modular nozzle assembly and a method for configuring a trigger or aerosol sprayer for a selected spray pattern includes a reconfigurable nozzle assembly with a replacement nozzle cap 150, 346 having modular fluidic circuit insert element retaining features 170, 172 or 376 and at least one detachable modular fluidic circuit insert element 152, 372 which a user may attach to the fluidic modular element retaining nozzle cap 150, 346.

### PRIORITY CLAIMS AND REFERENCE TO RELATED APPLICATIONS

This application claims priority benefit to (a) commonly owned co-pending patent application No. 61/971,078 filed on Mar. 27, 2014, the entire disclosure of which is incorporated herein by reference. This application is also related to commonly owned U.S. Pat. No. 7,354,008 entitled Fluidic Nozzle for Trigger Spray Applications, and PCT application number PCT/US12/34,293, entitled Cup-shaped Fluidic Circuit, Nozzle Assembly and Method (now WIPO Pub WO 2012/145537), the entire disclosures of which are hereby incorporated herein by reference.

### BACKGROUND OF THE INVENTION

Field of the Invention

The present invention relates to spray nozzles configured for use when spraying consumer goods such as cleaning fluids or personal care products. More particularly, this invention relates to a nozzle assembly for use with low-pressure, trigger spray or “product only” (meaning propellantless) applicators and in preferred embodiments to a modular spray nozzle assembly having multiple interchangeable fluidic circuit components.

Discussion of the Prior Art

Generally, a trigger dispenser for spraying consumer goods is a relatively low-cost pump device which is held in the hand and which has a trigger operable by squeezing or pulling the fingers of the hand to pump liquid from a container and through a nozzle at the front of the dispenser.

Such dispensers may have a variety of features that have become common and well known in the industry. For example, the dispenser may be a dedicated sprayer that produces a defined spray pattern for the liquid as it is dispensed or issued from the nozzle, but it is also known to provide dispensers with adjustable spray patterns so that with a single dispenser the user may select a spray pattern that is in the form of either a stream or a substantially conical spray of liquid droplets.

Many substances are currently sold and marketed as consumer goods in dispensers having containers with trigger sprayers. Examples of such substances include air fresheners, window cleaning solutions, personal care products and many other materials for other general spraying uses. Consumer goods using these dispensers are typically packaged as a container such as a bottle that carries a spray head, which typically includes a manually actuated pump, which a user aims at a desired surface or in a desired direction. The operating pressures of such manual pumps are generally in the range of 30-40 psi and typically emit conical sprays that are typically very sloppy, and which spray an irregular pattern of small and large drops.

Dispensers recently have been introduced into the marketplace which have battery operated pumps in which the operator only has to press the trigger once to initiate a pumping action that continues until pressure on the trigger is released. These devices typically operate at lower pressures than manually operated trigger sprayers, usually in the range of 5-15 psi. They also suffer from the same deficiencies as noted for manual pumps; plus, due to their lower operating pressures they appear to have even less variety in or control of the spray patterns that can be generated.

The sprayer heads for prior art dispensers typically incorporate nozzles of the one-piece molded “cap” variety, incorporating channels corresponding to either the offered “spray” or “stream” patterns that can be lined up with a feed channel coming out of a sprayer head assembly (see, e.g., Calmar's nozzle cap 28 as illustrated and described in U.S. Pat. No. 6,126,090, or nozzle member 24 as illustrated and described in U.S. Pat. No. 8,864,052 and shown in Prior Art FIGS. 1 and 2 herein). These nozzles traditionally include a “spin chamber” or “swirl cup” and the spray generated by such prior art nozzles (see, e.g., Calmar's nozzle as illustrated and described in U.S. Pat. No. 4,706,888) is generally “swirled” within the nozzle assembly to form a spray (as opposed to a stream) having droplets scattered across a wide angle, producing droplets of varying sizes and velocities.

The manually actuated sprayer of U.S. Pat. No. 6,793,156 to Dobbs, et al illustrates an improved swirl cup, or orifice cup, mounted within the discharge passage of a manually actuated hand-held sprayer. The cup is held in place by press fitting its cylindrical side wall within the wall of a circular bore. Dobbs' cup includes “spin mechanics” in the form of a spin chamber, wherein spinning or tangential flows are formed on the inner surface of a circular base wall of the orifice cup. Upon manual actuation of the sprayer, pressures are developed as the liquid product is forced through a constricted discharge passage and through the spin mechanics before issuing through the discharge orifice in the form of a traditional conical spray. If no spin mechanics are provided or if the spin mechanics feature is immobilized, the liquid issues from the discharge orifice in the form of a stream.

Typical orifice cups are molded with a cylindrical skirt wall, and have an annular retention bead that projects radially outwardly of the side of the cup near the front or distal end thereof. The orifice cup is typically force fitted within a cylindrical bore at the terminal end of a sprayer discharge passage in tight frictional engagement between the cylindrical side wall of the cup and the cylindrical bore wall. The annular retention bead is designed to project into the confronting cylindrical portion of the pump sprayer body, serving to assist in retaining the orifice cup in place within the bore as well as in acting as a seal between the orifice cup and the bore of the discharge passage. The spin mechanics feature is formed on the inner surface of the base of the orifice cup to provide a swirl cup which functions to swirl the fluid or liquid product and break it up into a substantially conical spray pattern.

In some prior art dispensers the traditional swirl nozzle geometry is integrated into the trigger sprayer's body, for example on a sealing post, and is completed by the exit aperture geometry (hole) contained on the nozzle cap. If the swirl geometry is not integrated into the sprayer's body, then it is typically in the back side of the trigger nozzle cap.

Typical prior art nozzle assemblies such as the foregoing are not satisfactory for users who want precisely patterned sprays of uniformly sized droplets. All of these nozzle assembly or spray-head structures with swirl chambers are configured to generate substantially conical atomized or nebulized sprays of fluid or liquid in a continuous flow over the entire spray pattern, but in fact the droplet sizes are poorly controlled, often generating “fines” or nearly atomized droplets. Other spray patterns (e.g., a narrow oval which is nearly linear) are possible, but the control over the spray's pattern is limited. None of these prior art swirl chamber nozzles can generate an oscillating spray of liquid or provide precise sprayed droplet size control or spray pattern control.

Oscillating fluidic sprays, such as those described in commonly owned U.S. Pat. No. 7,354,008, have many advantages over conventional, continuous sprays, and can be configured to generate an oscillating spray of liquid or to provide a precise sprayed droplet size control or precisely customized spray pattern for a selected liquid or fluid. The applicants have been approached by liquid product makers who want to produce dispensers with these advantages, but prior art fluidic nozzle assemblies have not been configured for incorporation with disposable, manually actuated sprayers like those described above.

In prior art fluidic circuit nozzle configurations, a fluidic nozzle is constructed by assembling a planar fluidic circuit or insert into a housing having a cavity that receives and aims the fluidic insert and seals the flow passage. A good example of a fluidic oscillator equipped nozzle assembly as used in the automotive industry is illustrated in commonly owned U.S. Pat. No. 7,267,290 (see, e.g., FIG. 3 of the '290 patent), which shows how a planar fluidic circuit insert is received within and aimed by the housing. Another example is found in FIGS. 3A and 3B of applicants' PCT/US12/34293, entitled Cup-shaped Fluidic Circuit, Nozzle Assembly and Method (now WIPO Pub. WO 2012/145537), the entire disclosure of which is incorporated herein by reference. In this application, a fluidic cup is configured as a one-piece fluidic nozzle which does not require a multi-component insert and housing assembly, and which incorporates fluidic oscillator features or geometry molded directly into the cup, which is then affixed to the nozzle. This fluidic cup conforms to the actuator stem used in typical aerosol sprayers and trigger sprayers and so replaces the prior art “swirl cup” that goes over the actuator stem. This fluidic cup is useful with both hand-pumped trigger sprayers and propellant filled aerosol sprayers and can be configured to generate different sprays for different liquid or fluid products.

Fluidic circuit generated sprays could be very useful in disposable, manually actuated sprayers, but adapting the fluidic circuits and fluidic circuit nozzle assemblies of the prior art would cause additional engineering and manufacturing process changes to the currently available disposable, manually actuated sprayers, thus making them too expensive to produce at a commercially reasonable cost.

There is a need, therefore, for a commercially feasible and inexpensive, disposable, manually actuated sprayer or nozzle assembly which provides the advantages of fluidic circuits and oscillating sprays, including precise sprayed droplet size control and precisely defined and controlled custom spray patterns for a selected liquid or fluid product.

### OBJECTS AND SUMMARY OF THE INVENTION

Accordingly, it is an object of the present invention to overcome the above mentioned difficulties by providing a commercially feasible, inexpensive, disposable, manually actuated fluid dispenser, or sprayer, incorporating a nozzle assembly which provides the advantages of fluidic circuits and oscillating sprays, including precise sprayed droplet size control and precisely defined and controlled custom spray patterns for a selected liquid or fluid product.

In accordance with the present invention, a new and improved modular nozzle assembly overcomes the disabilities of prior fluid dispenser spray assemblies by the provision of one or more fluidic plates, each configured to selectively create a corresponding precise 2-D or 3-D spray pattern of a liquid product. Existing trigger spray nozzles for use in spraying consumer goods are reconfigured to include snap-on features that enable a user to change their outputs from a traditional spray (swirl) type to a selected fluidic plate having a desired fluidic-circuit generated output spray configuration. To accomplish this, a modular spray head assembly incorporates a nozzle cap having first and second opposed slots or snap openings on opposite sides of a central flow supply opening. These slots are configured to receive and support ‘snap on’ features such as mounting tabs on a modular fluidic plate component. This new “snap-on” fluidic plate is configured for installation on the face of a nozzle cap, with the mounting tabs engaging the slots, or snap openings, on the cap, and is easily configured to fit pre-existing or new similarly designed trigger spray nozzle caps with attachment features.

The modular snap on fluidic plate is preferably configured as a planar generally disc-shaped fluidic circuit insert for use in a modular spray head assembly and has a two channel oscillation-inducing geometry defined in an underside, or proximal (near), side of the disc. The fluid oscillation-inducing geometry is preferably molded into the underside or proximal side of the fluidic plate and is defined by a chamber having a central interaction region located between a first power nozzle and second power nozzle, and which is in fluid communication with a discharge orifice extending through the plate from the fluidic circuit to the distal plate surface. The first power nozzle is configured to accelerate the movement of passing pressurized fluid flowing through it to form a first jet of fluid flowing into the chamber's interaction region, and the second power nozzle is similarly configured to accelerate the movement of passing pressurized fluid flowing through it to form a second jet of fluid flowing into the chamber's interaction region. The first and second jets so formed collide and impinge upon one another in the interaction region at a selected inter-jet impingement angle (e.g., 180 degrees, meaning the jets impinge from opposite sides). This impingement generates oscillating flow vortices of spray droplets within the interaction region, and these oscillating flow vortices cause the spray droplets to flow through the discharge orifice as an oscillating spray of substantially uniform fluid droplets in a selected 2-D or 3-D spray pattern having a selected spray width and a selected spray thickness. The fluidic circuit incorporated in the modular insert of the present invention is configurable to function in a manner similar to the fluidic circuit illustrated in the above-mentioned PCT/US12/34293 application.

In brief, then, the modular nozzle assembly of the invention, in a preferred form, incorporates one or more user selectable and user changeable fluidic plates or fluidic circuit members which are each configured to create precise 2-D or 3-D spray patterns of a liquid product. The fluidic circuit members may be incorporated in a sprayer kit to provide a user configurable modular nozzle assembly for configuring a trigger sprayer for a selected spray pattern. The kit may also include a nozzle assembly with a nozzle cap having a retaining feature, such as retainer slots, for receiving and removably securing a selected one of the modular fluidic circuit insert elements provided in the kit. A user may use the kit to replace an existing nozzle, if it does not incorporate a retaining feature, and may select a desired fluidic circuit member from the kit for assembly to the nozzle and to the dispenser to provide a selected nozzle spray configuration. The kit components may be used with a dispenser nozzle that incorporates a traditional swirl nozzle geometry integrated into the trigger sprayer's body, for example on a sealing post, but applicants prefer that the trigger sprayer body or nozzle cap not have a swirl geometry and thus prefer to replace a swirl geometry with a basic planar sealing surface to allow for the conventional ON/OFF shut off function to remain via the fluid feed channels.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE FIGURES

FIGS. 1 and 2 illustrate in a cross-sectional view and in an exploded perspective view, respectively, an economical trigger dispenser in accordance with the prior art, having a spray head nozzle assembly configured to selectively provide “stream” or “spray” fluid product spray patterns:

FIG. 3 is a perspective end view of a prior art trigger dispenser spray head with its cover, or cap, removed to illustrate a traditional swirl nozzle geometry integrated into the trigger sprayer's body, for example on a nozzle sealing post;

FIG. 4 is a perspective end view of another prior art spray head with its cover removed to illustrate a sealing post having a circular distal sealing surface without a swirl nozzle geometry;

FIG. 5A is a plan view of the interior of a spray head cover, or cap, for the nozzle of FIG. 3, illustrating a swirl-producing geometry incorporated in the distal or outlet end of the cover; and incorporating snap on tabs for securing it to a spray nozzle;

FIGS. 5B and 5C are a plan front (exterior) view and a plan rear (interior) view, respectively, of a modified version of the spray cap of FIG. 5A, configured for use with the sealing post of FIG. 4;

FIGS. 6, 7 and 8 illustrate applicant's own prior art aerosol spray dispenser nozzle incorporating a fluidic circuit configured in the distal surface of a unitary cup-shaped nozzle, and plan views of a fluidic circuit for the nozzle;

FIG. 9 is a perspective view of a spray head cover, or cap, forming a part of a modular fluidic spray nozzle assembly in accordance with the present invention;

FIG. 10 is a plan view of a distal end surface of a modular fluidic circuit plate configured for attachment to the modular spray head cover or cap of FIG. 8;

FIG. 11 is a cross-sectional view of the modular fluidic circuit plate of FIG. 10, taken along line 11-11 of FIG. 10;

FIG. 12 is a perspective end view of a modified form of a modular spray head cover in accordance with the present invention, illustrating an offset spray dispenser;

FIG. 13 is a view of another prior art trigger spray dispenser device for producing swirled or jet fluid sprays;

FIG. 14 is a perspective sectional view of the interior of the prior art nozzle member of the dispenser of FIG. 13;

FIGS. 15 and 16 are cross-sectional views of the prior art nozzle member of FIG. 14;

FIG. 17 is a front plan view of the nozzle member of FIG. 14, with sectional lines 15-15 and 16-16 showing the section lines for FIGS. 15 and 16, respectively;

FIG. 18 is a rear plan view of the interior of the nozzle of FIG. 14;

FIG. 19 is a sectional view of a nozzle member similar to the nozzle member of FIG. 14, except for a modification wherein the modified nozzle is adapted to receive, align and retain a fluidic circuit oscillating spray generating member, illustrating the area of modification for receiving the modular fluidic circuit in accordance with the invention;

FIGS. 20 and 21 are interior and exterior views, respectively of the modular fluidic circuit plate member configured for attachment within the modified nozzle member of FIG. 19;

FIG. 22 is a sectional view of another embodiment with a nozzle similar to the nozzle member of FIG. 14, except for a second alternative modification wherein the modified nozzle is adapted to receive, align and retain an attachable and removable cup-shaped fluidic circuit oscillating spray generating member, illustrating the area of modification for receiving the attachable and removable cup-shaped modular fluidic circuit in accordance with the invention; and

FIGS. 23 and 24 are interior and exterior views, respectively of another embodiment of the cup-shaped attachable and removable fluidic circuit member for assembly with the modified nozzle member of FIG. 22.

### DESCRIPTION OF THE PREFERRED EMBODIMENT

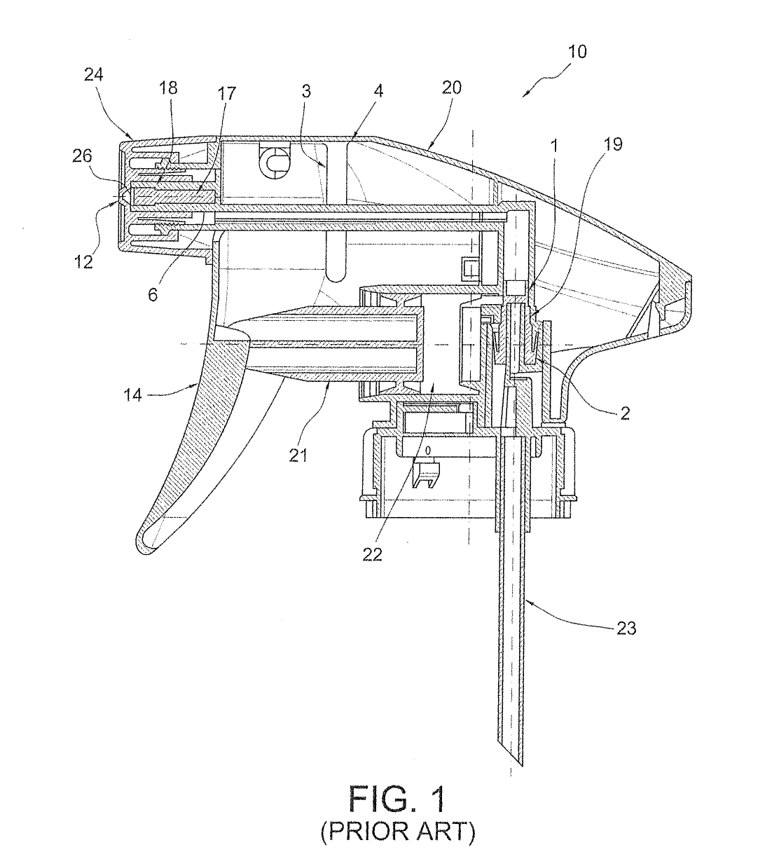

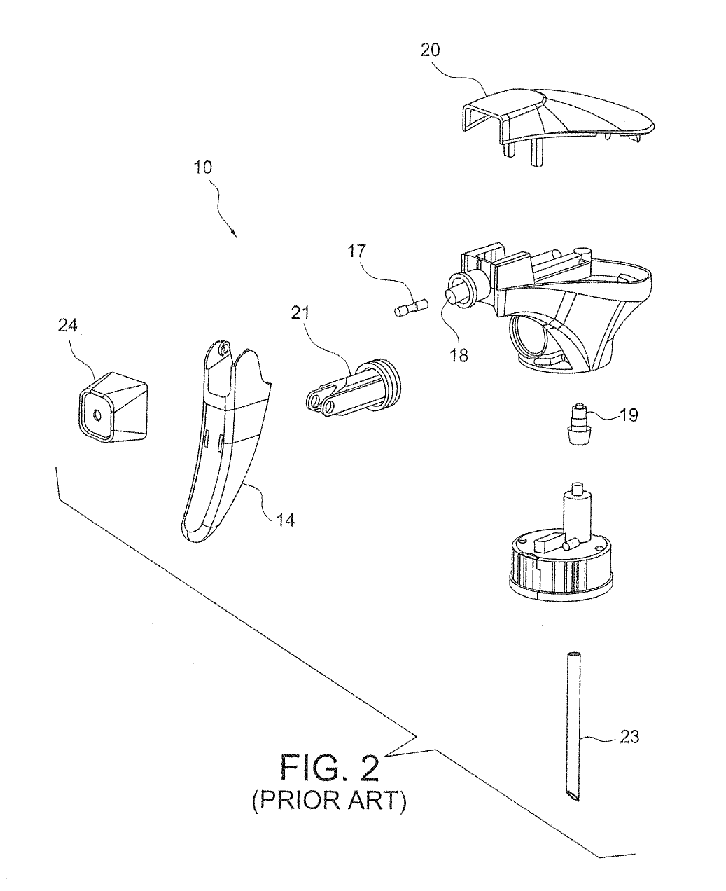

Turning now to a more detailed consideration of the drawings, FIGS. 1 and 2 provide an example of an inexpensive commercial trigger spray dispenser and to illustrate its principal components. Such a sprayer typically is made of plastic materials and can be manufactured to dispense many liquid products, ranging from household chemicals, lawn and garden products, to automotive products, and the like. As illustrated, the sprayer 10 incorporates an opposing valve system which uses a piston 21 for compressing a liquid product which is drawn into the piston bore area 22. A dip tube 23 is used to pull a liquid product from a bottle or other container (not shown) through a check valve 19 into the piston chamber in response to a return motion of the piston. Once the liquid is drawn into the piston chamber past a check valve area 2, the piston is pushed back into the bore by an actuator 14, moved by an operator against a return spring 3 secured to the inner surface 4 of a trigger sprayer cover 20, thereby closing the check valve and opening a priming valve area 1, to force the liquid distally through a sealing post 17 into a nozzle member 24. This forces the liquid into a swirl chamber 26 and out a nozzle orifice 12, which generates a distally projecting spray, stream or foam, depending on the type of configuration of the swirl chamber, when the liquid is expelled through nozzle orifice 12.

The distally projecting sealing post 17 in the low cost trigger sprayer 10 shown in FIGS. 1 and 2 may include a swirl nozzle component. This sealing post is designed as a simple, easily manufactured component that is tubular in shape and which allows for easy assembly into the housing component 6. The tubular or cylindrical shape of sealing post 17 also eliminates excess clearance inside of the area 18 of housing 6.

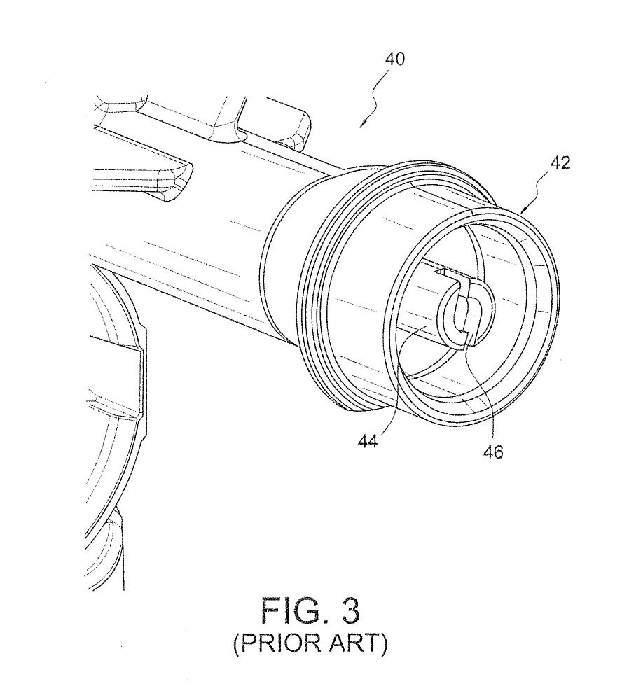

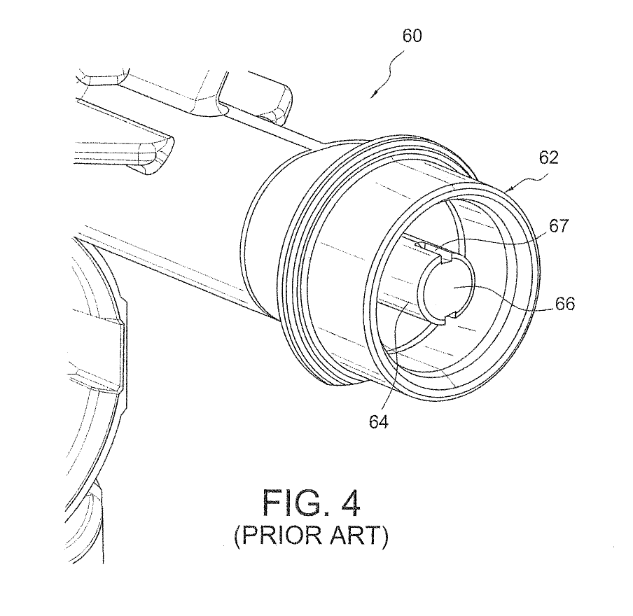

FIG. 3 illustrates at 40 a perspective end view of another prior art trigger sprayer that is similar to the sprayer of FIGS. 1 and 2, having a spray head 42 with its spray head cover, or cap, removed to reveal a distally projecting, tubular sealing post 44. As illustrated, this sealing post incorporates a swirl nozzle component 46 formed in the distal end of the post to impart a swirling motion to ejected fluids. FIG. 4 is a perspective end view of a prior art trigger sprayer 60 that is similar to the device of FIG. 3, having a spray head 62 with its spray head cover removed to reveal a distally projecting tubular sealing post 64. As here illustrated, this sealing post differs from that of FIG. 3 in that it does not incorporate a swirl nozzle component, but is a hollow tubular member with a basic sealing device 66 at its terminal end, and having fluid exit slots 67 in the sealing post side wall. FIG. 5A illustrates a spray head cover 70 for the spray head 42 of FIG. 3, having an outlet orifice 72 and a swirl nozzle geometry in the structure to impart a swirling motion to ejected fluid. FIGS. 5B and 5C illustrate front and rear plan views, respectively of another nozzle cap 76 for the distally projecting sealing post 60 of FIG. 4, constructed flow apertures 77 to allow fluid flow to pass distally through the cap without additional impedance.

The present invention (to be described) may be used with dispensers having preexisting sealing post swirl geometry (like that illustrated in FIG. 3) in place, but it is preferred that when the modular system of the invention is used with such devices, the original swirl geometry be replaced with the basic sealing device 66 to allow the conventional on-off function to remain, using fluid feed channels 67 in the side wall of the sealing post. This enables the full benefits of the fluidic circuit structures of the invention to be obtained.

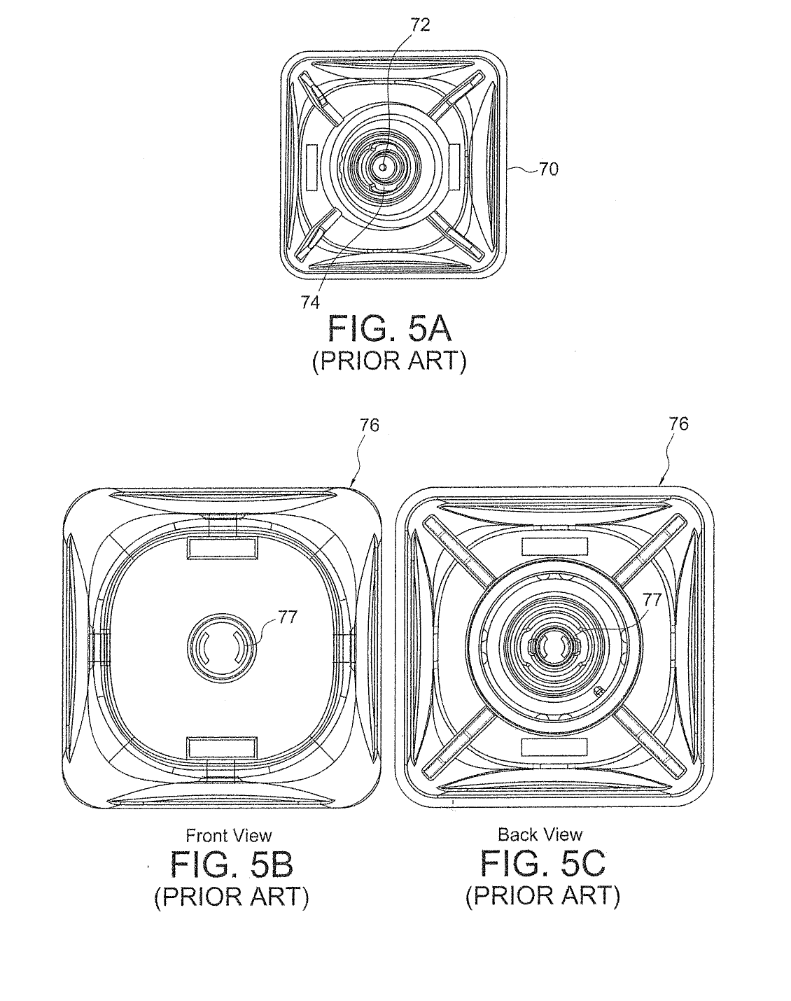

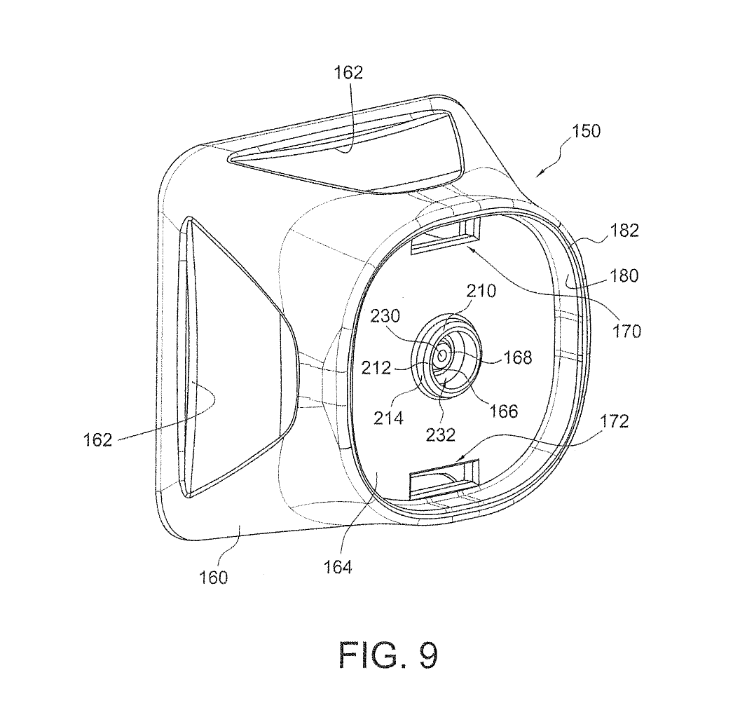

Another example of applicant's own prior art is illustrated in FIGS. 6-8, taken from FIGS. 9B, 3A and 3B, respectively, of applicant's PCT/US12/34293, described above, wherein a fluidic nozzle is constructed by permanently affixing a planar fluidic circuit within a weatherproof housing having a cavity that receives and aims the fluidic insert and seals the flow passage. In this application, a spray head 78 incorporates a fluidic cup 80 to produce an output fluid spray 82. The cup 80 replaces the typical swirl cup and incorporates a fluidic circuit, or fluid oscillator 84, having fluidic features or geometry which may be molded directly into the front, or distal wall 86 of the cup. This fluidic cup 80 conforms to sealing post 88, as used in typical aerosol sprayers and trigger sprayers, and so replaces the prior art “swirl cup” that goes over the sealing post. Alternatively, the fluidic circuit may be formed in a separate component 90 which is secured in the front wall of the cup before assembly. This fluidic cup is useful with both hand-pumped trigger sprayers and propellant-filled aerosol sprayers and can be configured with different fluidic circuits to generate different sprays for different liquid or fluid products.

The cup-shaped fluidic nozzle 80 is mounted in a dispenser body member 92 of the spray head, and has a peripheral wall 94 extending proximally into a bore 94 in the body 92, radially outwardly of the sealing post 88, to form a fluid passageway 98. The distal, or radial end wall 86 of cup 80 has an inner face opposing the sealing post's distal or outer face 100 to define a fluid channel 102 including a chamber having an interaction region 104 between the sealing post and the fluidic circuit component 84 on the distal wall 86. The chamber 104 is in fluid communication with the fluid passage 102 to define a fluidic circuit oscillator inlet so that pressurized fluid indicated by arrows 110 can enter the fluid interaction region and be ejected as a spray 82 having a pattern defined by the fluidic circuit.

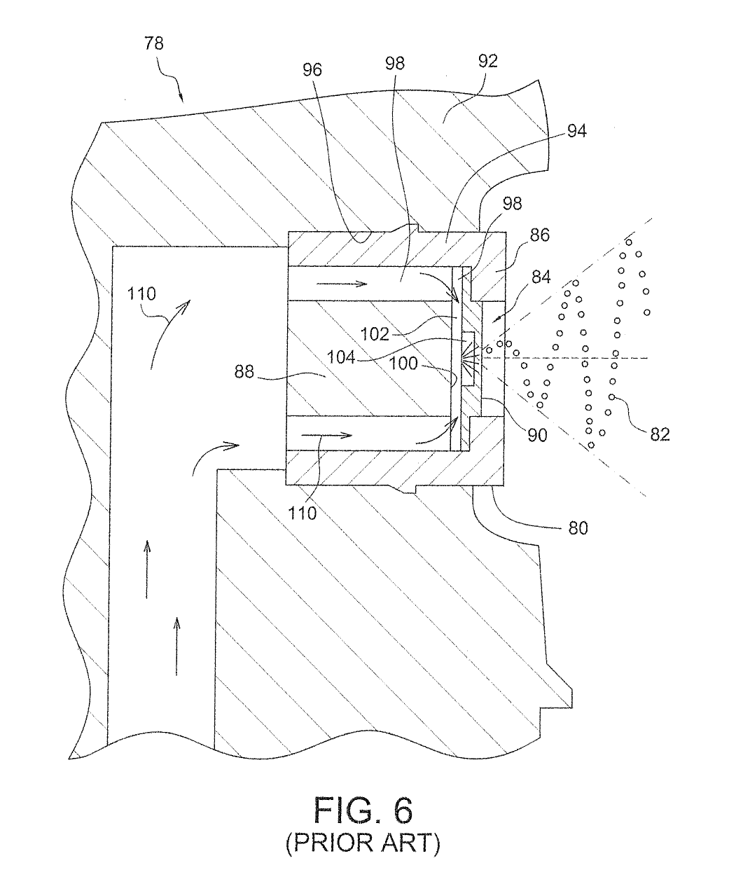

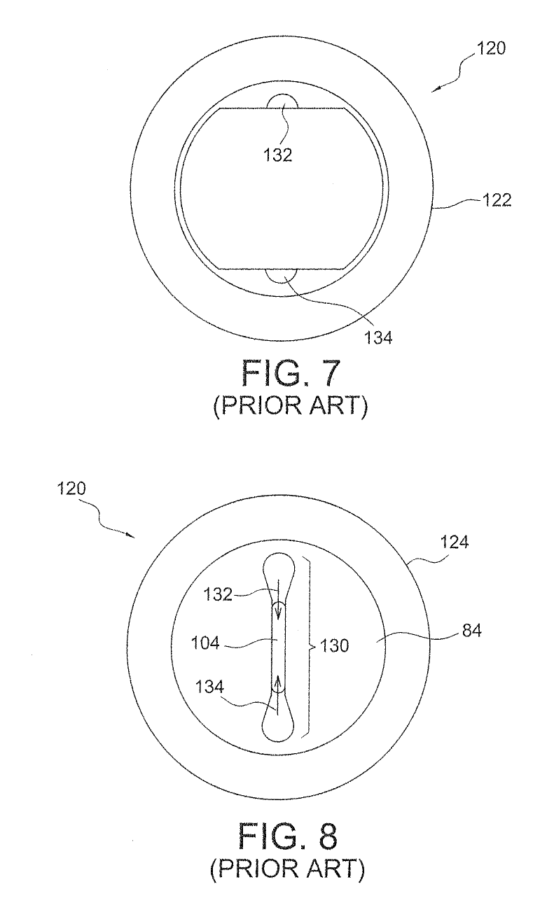

FIGS. 7 and 8 illustrate a two channel oscillation-inducing fluidic circuit geometry 120 having fluid steering features and configured in the circuit component 84, in this case in the form of a planar disk having an underside or proximal side 122 (FIG. 7) opposing a distal side 124 (FIG. 8). Fluid oscillation-inducing geometry 130 is preferably molded into underside or proximal side 122. In the illustrated embodiment, oscillation-inducing geometry 130 operates within a chamber including interaction region 104 between a first power nozzle 132 and second power nozzle 134, where first power nozzle 132 is configured to accelerate the movement of passing pressurized fluid flowing through the first nozzle to form a first jet of fluid flowing into the interaction region 104, and the second power nozzle 134 is configured to accelerate the movement of passing pressurized fluid flowing through the second nozzle to form a second jet of fluid flowing into the interaction region 104. The first and second jets collide and impinge upon one another at a selected inter-jet impingement angle (e.g., 180 degrees, meaning the jets impinge from opposite sides) and generate oscillating flow vortices within interaction region 104 which is in fluid communication with a discharge orifice or power nozzle defined in the fluidic circuit's distal side surface, and the oscillating flow vortices spray droplets through the discharge orifice as an oscillating spray 82 of substantially uniform fluid droplets in a selected (e.g., rectangular) spray pattern having a selected spray width and a selected spray thickness.

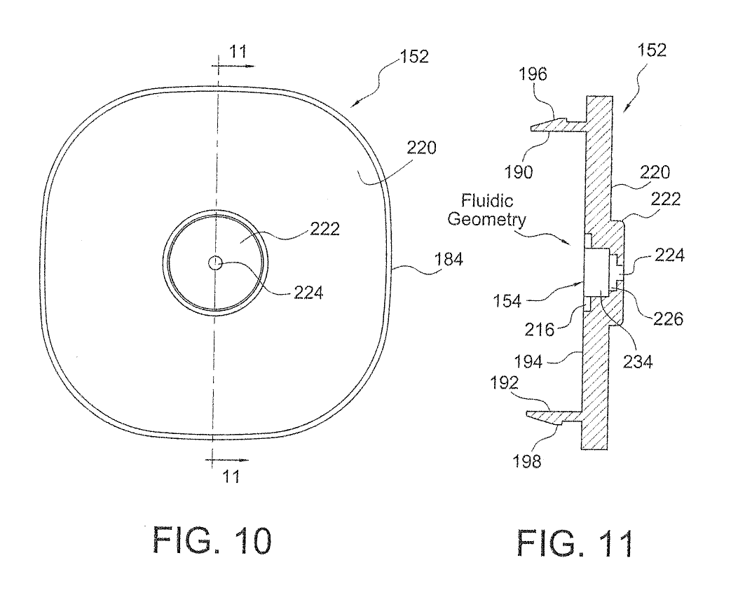

The shortcomings of the prior art have been discussed hereinabove, and to overcome these in order to provide a modular fluidic spray system which may be in the form of a kit or collection of various modular components which may be assembled to provide the consumer or user with several distinct selectable spray configurations, the present invention provides a modular assembly, embodiments of which are illustrated in FIGS. 9-24, to which reference is now made. As illustrated, the sprayer of the present invention incorporates many of the components of commercial trigger sprayer assemblies such as that illustrated in FIGS. 1 and 2, but discards the standard spray head or nozzle member 24 and replaces it with a modular assembly which preferably includes a replacement spray head or cap member 150 and one or more user-replaceable fluidic circuit components such as the plate 152 illustrated in FIGS. 10 and 11. A single spray head receives user selectable and user installable oscillating spray generating components, so that the modular assembly of the present invention may comprise parts of a kit with disc-shaped or cup shaped fluidic oscillating spray generating components that can be selected for use by the consumer to generate different kinds of precisely controlled sprays for different uses.

The modular nozzle assembly of the invention includes a spray head, or nozzle member 150 that is configured to receive a detachable fluidic circuit carrier 152, here illustrated as a plate, or disc, and in some configurations as a cup-shaped member (to be described). The carrier incorporates a fluidic circuit 154 configured to selectively create precise 2-D or 3-D spray patterns of a liquid product for use by consumers for dispensing or applying liquid products. As illustrated, the nozzle cap member 150 is generally cup-shaped, having a side wall 160 shaped to be secured to the front end of a conventional dispenser housing such as that illustrated in FIG. 1; for example, the wall 160 may incorporate internal shoulders 162 extending inwardly to engage corresponding slots or shoulders on the dispenser to provide a secure snap-on fit.

The nozzle cap member 150 has a distal end wall 164 having a central aperture 166 for receiving, when placed on a dispenser, a conventional tubular sealing post 168, similar to the sealing post 17 of the device of FIG. 1. On opposite sides of the central aperture 166, the end wall 164 incorporates a snap-on feature such as first and second mounting slots 170 and 172 adapted to receive and removably retain corresponding first and second snap-on tabs 174 and 176 located on a back surface 178 of detachable fluidic plate 152.

In the illustrated embodiment, the fluidic circuit modular component or plate 152 is generally disc-shaped, or circular, as viewed in the front plan view of FIG. 10, but this shape is modified to match the shape of the distal receiving surface of end wall 164 of the spray cap modular member or nozzle cap 150 of FIG. 9. As illustrated, the nozzle cap member 150 includes an upstanding peripheral rim, or flange 180 surrounding its end wall 164 to define the distal receiving surface. Flange 180 has an inner peripheral shoulder 182 which receives the peripheral edge 184 of the modular plate 152 when the plate is positioned on the front of the nozzle member. When so positioned, tabs 190 and 192 located on the back, or proximal surface 194 of the plate 152, provide some spring-bias to deflect and pass through corresponding slots 170 and 172 in the front surface 164 of nozzle member 150. Detents or retention shoulders 196 and 198 on the tabs snap over corresponding edges of the slots to removably secure modular plate 152 onto the face of nozzle member 150, within the rim 180.

More particularly, the fluidic circuit modular disc or plate 152 carries, on it's back or interior surface a first latching tab 190 projecting proximally away from the interior surface near the plate's periphery, and that first latching tab 190 has a beveled head defining an angled surface which tapers outwardly from the proximal tip to a barb-like retaining edge 196 which faces the fluidic circuit modular plate's peripheral edge 184. On the opposing edge of plate peripheral edge 184, a second latching tab 192 is spaced apart from the first latching tab 190 and projects proximally away the back or interior surface and the second latching tab also has a beveled head defining an angled surface which tapers outwardly from a proximal tip to a barb-like retaining edge 198 which faces away from the first tab's beveled taper and toward the plate's circular periphery. First and second latching tabs 196 and 198 are configured to snap into and releasably engage corresponding slots 170, 172 within the distal exterior surface of spray cap modular member 150, and by the spring bias force of the latching tabs, press the plate into the spray cap to define a fluid tight connection therebetween.

Surrounding the sealing post 168 and the aperture 166 in the front wall of nozzle 150 is an upstanding central sealing wall 210 having a central rim 212 surrounded by a stepped shoulder 214. When the plate 152 is snapped into place on the face of nozzle member 152, the rim 212 of central wall 210 engages a corresponding annular channel 216 on the proximal (inner) surface 194 of plate 152 and shoulder 214 engages the inner wall surface 194 to enclose the sealing post 168. This forces fluid flowing from the dispenser into the fluidic circuit 154 on the back of plate 152.

The outer, or distal surface 220 of plate 152 has a central raised portion 222 through which extends a spray orifice 224. The fluidic circuit 154 is formed in the rear, or proximal surface 194 of the plate, as by molding, and in known manner consists of a central interaction region 226 at the intersection of power nozzles (see FIG. 8, for example). The fluidic circuit, as here illustrated, is centrally located in the raised portion 222 of plate 152 and is axially aligned with the sealing post when the plate and nozzle member are assembled. When the nozzle member and plate assembly is secured to a dispenser, fluid from the dispenser flows through a central flow channel 230 in the sealing post 168 (see FIGS. 3 and 4, for example), or around the sealing post (see FIG. 6, for example), into the interior 232 of sealing wall 210 and into a chamber 234 at the back surface of plate 150 in fluid communication with the fluidic circuit. The fluid then flows into and through the power nozzles to form in the interaction region 226 a venturi which flows out of the spray orifice 224 to dispense fluid in a spray pattern defined by the configuration of the fluidic circuit. The modular nozzle assembly of FIGS. 9 and 10 aligns the central axis of the spray head's distally projecting sealing post (e.g., 17, 46 or 66) with the central axis of spray cap modular member 150 and with the discharge orifice 224 of fluidic circuit modular component member 152, so all are coaxially aligned along a single spray axis.

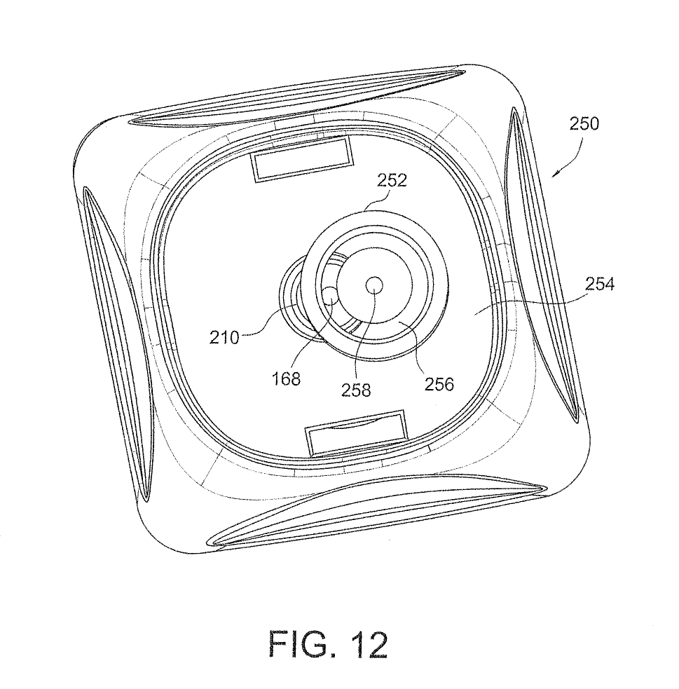

Although the foregoing describes a unit having a centrally located spray outlet or discharge orifice 224 on fluidic plate 152, it will be recognized that it may be desirable to provide a plate having an offset spray outlet orifice, so that the spray issues from an orifice near the top, bottom, or one side of the nozzle member. In such a case, the fluidic circuit would be misaligned with the centrally-located sealing post (e.g., 17, 46 or 66), as shown in the embodiment illustrated in FIG. 12. To accommodate such a situation, the nozzle member 150 may be modified, as is illustrated diagrammatically for nozzle member 250 in FIG. 12. In this case, the central raised portion 252 on fluidic circuit plate 254 is offset, but the chamber 256 (equivalent to chamber 234 in FIG. 11) is still in fluid communication with the fluid flow through or around the sealing post (e.g., aligned along axis 168), and with the sealing wall 210 still engaging the rear (proximal) surface of the plate 254. Modular nozzle assembly 250 thus has the spray head's distally projecting sealing post axis offset from the fluidic circuit modular component member's discharge orifice 252 to provide spray along a second axis which is parallel to but spaced from the sealing post axis. Since the spray cap modular member is rotatable around the sealing post axis, the spray which issues from the orifice 258 can have (e.g., for a flat, fan shaped spray pattern) differing fan orientations when the cap member is rotated through the top spray, bottom spray, or side spray orientations.

Nozzle members such as that illustrated at 150 in FIG. 9 may be conventional snap-on type nozzles for dispensers in which snap-on slots 170 and 172 are provided to accept conventional swirl geometry caps. In such a case, replacement fluidic circuit plates such as plates 152 and 254 may be provided as a modular kit to convert the swirl device to a fluidic circuit device, it being understood a number of such plates, each having a different fluidic circuit configuration, may be provided, allowing the user to assemble a selected plate to the nozzle member to enable the dispenser to produce a selected fluidic oscillation spray output. Alternatively, a snap on nozzle member may be included as a part of the modular kit for use in the event that the nozzle member of a conventional dispenser does not incorporate suitable snap on components such as the receptacles or slots 170 and 172. In either case, the modular kit enables the user of a conventional spray dispenser to convert it to a fluidic device by selecting a desired panel from a multiplicity of panels, each carrying a distinct fluidic circuit having a geometry designed to produce a corresponding 2-D or 3-D output fluid spray pattern. A modular kit may incorporate any desired number of replacement fluidic spray panels and compatible spray nozzle members.

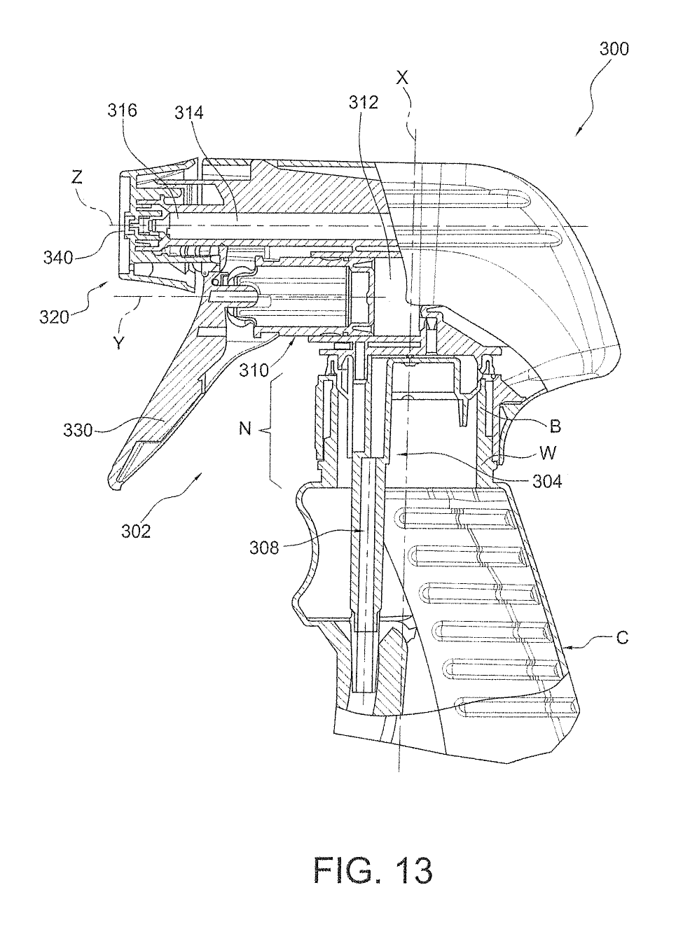

Another application of the modular fluidic circuit system of the invention is illustrated with respect to a prior art fluid trigger spray dispenser known as a “Starblaster”, illustrated in FIGS. 13-18, to which reference is now made. This trigger sprayer or dispenser, which is generally illustrated at 300 in FIG. 13, is described in detail in U.S. Pat. No. 8,931,668, issued on Jan. 13, 2015 to Alluigi et al. This device incorporates a container C for liquid to be dispensed, and a neck N made by an annular wall W around a container axis X to define, by means of an annular rim B, a container aperture A for access to the inside of the container. The dispenser device 300 carries a dispenser head 302 attached to the container C to manually aspirate the liquid from the container and spray or dispense it in the direction of the Z axis. The head 302 further comprises an auxiliary body 304 attached to the neck N of the container C, at the aperture A of the same, to close it, peripherally forming a seal. The auxiliary body 304 has a primary liquid aspiration duct 308 extending coaxially with the container axis X to supply fluid to a piston assembly 310 in the sprayer head 302.

The piston sealingly slides in a pressure chamber 312 along a pressure axis Y, between a rest position, wherein the volume of the pressure chamber is maximum, and a limit dispensing position, wherein the volume of the pressure chamber is minimal, passing through intermediate dispensing positions. The spray head incorporates a dispenser duct 314 extending along the dispensing axis Z, to a distal extremity 316, at a nozzle member 320, which is attached to the distal extremity 316 of the dispenser duct 314, to enable spraying or dispensing of the liquid in the desired manner. The pressure chamber 312 is in fluidic communication with the dispenser duct 314.

The sprayer head 302 includes valve dispenser apparatus suitable for allowing the transit of liquid from the pressure chamber 312 to the dispenser duct 314 when, during the dispensing phase, the piston 310 moves from a rest position towards a dispenser limit position, and the liquid exceeds a predefined pressure threshold. The valve dispenser may comprise an elastically deformable diaphragm attached to a dispenser frame 322, which has a secondary liquid aspiration duct that co-operates in the connection of the pressure chamber 312 with a compartment inside the container. The head 302 thus comprises valve dispenser means suitable for allowing the transit of liquid towards the pressure chamber 312 when, during a return phase, the piston moves towards its rest position from its dispenser limit position, and prevents transit of the liquid from the pressure chamber during the dispensing phase. Thus, in its initial rest configuration, the piston is in the rest position, the valve dispenser is closed, the valve aspiration apparatus is closed, the air aspiration passage towards the outside is closed, and the presence of liquid to dispense in the pressure chamber 312 is presumed. In the dispensing phase, the piston completes a dispensing stroke from the rest position to the limit dispensing position by manual activation of a trigger 330. By effect of the liquid in the pressure chamber, the liquid aspiration valve remains closed, preventing the backflow of liquid towards the container. Similarly, by effect of the pressurized liquid, the valve dispenser is open, making the liquid travel from the pressure chamber 312 to the dispenser duct 314, thereby enabling dispensing from the nozzle 320 via an exit orifice 340.

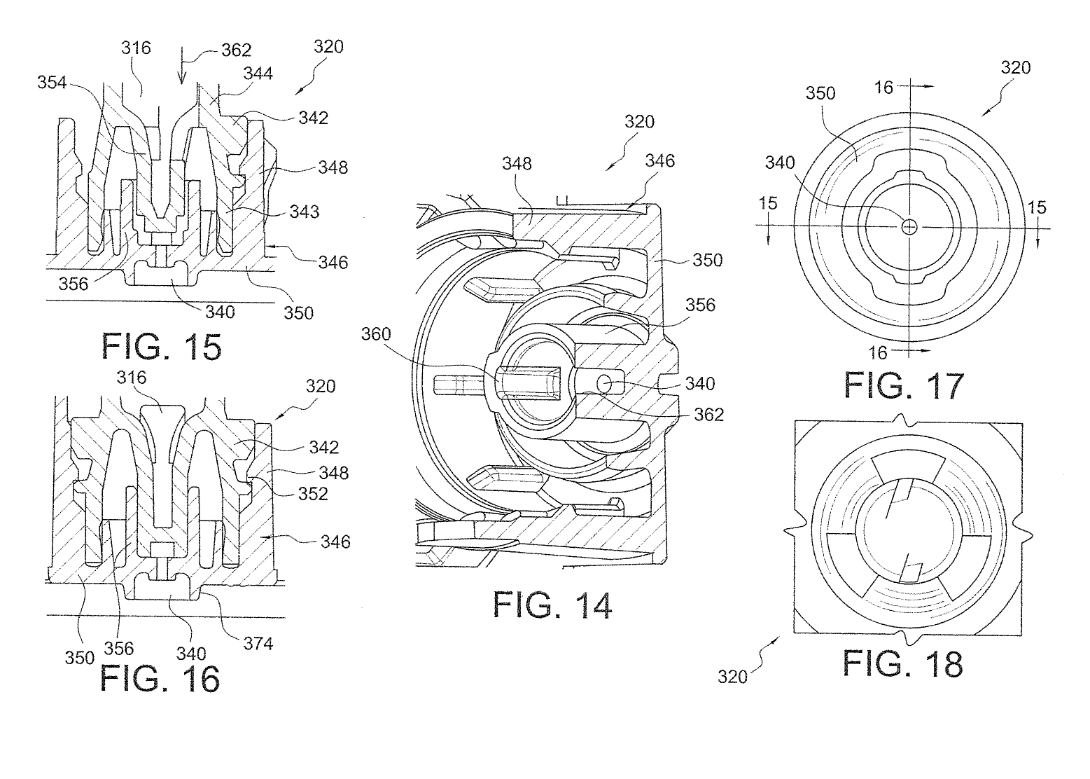

An embodiment of the nozzle member 320 is illustrated in enlarged detail in FIGS. 14-18, to which reference is now made. As there illustrated, the nozzle incorporates a fluid flow channel member 342 having an outer cylindrical wall 343 connected at its proximal end 344 to the distal end 316 of the fluid flow duct 314. Secured to the outer wall 343 of channel member 342 is a generally cup-shaped spray guide 346 having an outer generally cylindrical wall 348 and a front or distal wall 350 in which is located the outlet orifice 340. The outer wall 348 is shaped to snap on to the outer wall 343 of channel member 342, having interior retention beads, or detents 352 to engage a corresponding shoulder on the outer surface of the channel member and to removably secure the components in assembled relationship. The fluid channel member also incorporates an inner cylindrical wall, or sealing post 354 which receives a corresponding inner cylindrical wall 356 of the spray guide 346. Suitable flow openings 360, 362 are formed in the wall 356 to allow fluid 362 (FIG. 15) to flow from the duct 314 into the channel member 342 and into the interior of wall 356 to the exit orifice 340.

It will be understood that the illustration of FIGS. 14-18 are merely exemplary of the illustrated type of nozzle, and that variations in the fluid flow both through and around the central stem portion 354 to the exit orifice may vary. However, as shown below, the type of dispenser nozzle illustrated by this prior art can also be converted to a modular fluidic circuit system in accordance with the present invention, so that the dispenser nozzle is adapted to accommodate fluidic circuits selected, for example, from available circuit configurations provided in a modular spray controller kit, as illustrated in the following figures.

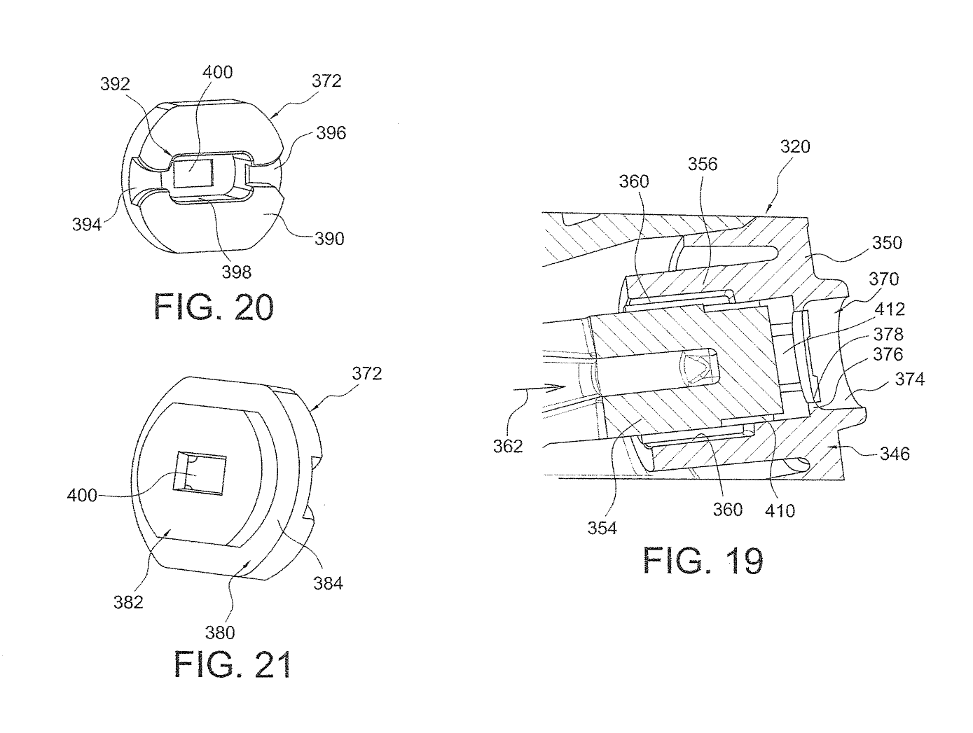

For example, in FIGS. 19-21, the nozzle 320 of FIG. 14 is modified by changing the spray guide 346 in the region indicated by box 370 to incorporate a fluidic circuit plate 372 such as that illustrated I FIGS. 20 and 21. This modification replaces a central portion of the forward wall 350 of the spray guide, removing the prior exit orifice 340 and leaving its surrounding shield 374 and an inwardly (radially) extending shoulder 376 surrounding a substantially circular central opening 378. The forward wall 380 of plate 372 has a raised central region 382 and a surrounding shoulder surface 384 which are shaped to engage and be secured in the opening 378. The plate 372 incorporates on its rearward (proximal) surface 390 a fluidic circuit incorporating a pair of tapered power nozzles 394 and 396 leading to a centrally-located interaction chamber 398 and an exit orifice 400.

By replacing the generally cup-shaped spray guide 346 of FIG. 19 with a spray guide modified by the substitution of the fluidic plate 372 into opening 378, or a similar plate having some other selected fluidic circuit configuration, the dispenser is converted to a fluidic controlled oscillating device with all the advantages in spray control and configuration described above. The spray guide 346 may be a snap-on device, incorporating the outer wall portion 348 and the inner wall portion 356 arranged to removably engage the wall 342 and the sealing post 354 of the nozzle member, so that a dispenser spray pattern may be easily changed by a user simply removing one modular spray guide and replacing it with another similar modular device incorporating a desired fluidic circuit geometry.

It will be understood that substitution of a spray guide incorporating a fluidic plate, such as that illustrated at 372, in the device of FIG. 19 creates a fluid flow path through grooves 360 in the wall 356 of spray guide 346 (also shown in FIGS. 14 and 15) and grooves 410 on the sealing post 354 to a chamber 412 in communication with the power nozzles 394 and 396 to create a vortex in the interaction chamber, with the vortex exiting the nozzle via outlet orifice 400.

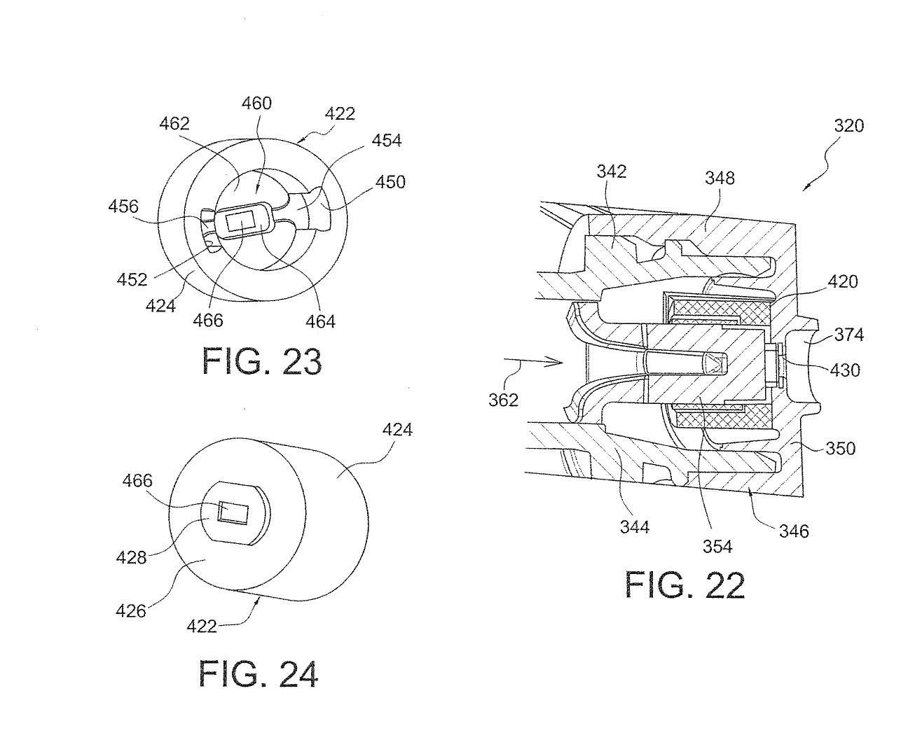

A similar modification of the dispenser nozzle member 320 illustrated in FIG. 14 is shown in FIGS. 22-24, wherein the nozzle member is modified in the region indicated at box 420 by replacing the inner wall 356 (indicated by cross-hatching) with a deep cup-shaped fluidic circuit carrier 422. The carrier includes a side wall 424 and a distal end wall 426 having a raised central region 428 shaped to fit into and engage a corresponding opening 430 in the end wall 350 of spray guide 346. When the carrier 422 is secured in place and the spray guide is inserted into the end of the nozzle member 320, the side wall 424 of the carrier extends over the sealing post 354 to hold the spray guide in place. The outer wall 348 also engages the nozzle wall 342 to further secure the spray guide. As seen in the interior view of carrier 422 in FIG. 23, the inner surface of wall 424 incorporates a pair of fluid channels 450, 452 that lead to a corresponding pair of power nozzles 454 and 456 in a fluidic circuit 460 in the inner (proximal) surface 462 of end wall 426. The power nozzles lead to an interaction chamber 464 for creating a fluid vortex which carries the fluid out of exit orifice 466.

In summary, and referring to the figures and description above, persons having skill in the art will appreciate that the disclosure of present invention provides, among other things, a conformal, unitary, one-piece fluidic circuit modular component configured for easy and economical incorporation into a modular trigger spray nozzle assembly or aerosol spray head actuator body including a distally projecting sealing post and a lumen for dispensing or spraying a pressurized liquid product or fluid from a transportable container to generate an exhaust flow in the form of an oscillating spray of fluid droplets, comprising the following illustrated features:

(a) a disc-shaped or cup-shaped fluidic circuit modular component or carrier having a transverse inner face with features defined therein and configured to abut or receive an actuator sealing post's transverse, planar end face surface; and

(b) the fluidic circuit modular component or carrier's inner face having surfaces comprising a fluid channel including a chamber when the fluidic circuit modular component or member is configured to be detachably fitted to the spray head actuator body's sealing post or removed by a user or consumer.

Preferably, the fluidic circuit modular component or member's chamber is configured to define a fluidic circuit oscillator inlet in fluid communication with an interaction region so when the fluidic circuit modular component is fitted to the body's sealing post and pressurized and fluid is introduced via the actuator body, the pressurized fluid may enter the fluid channel's chamber and interaction region and generate at least one oscillating flow vortex within the fluid channel's interaction region. The disc-shaped or cup shaped member's transverse distal wall includes a discharge orifice in fluid communication with the chamber's interaction region, and the chamber is configured so that when the fluidic circuit modular component is fitted to the body's sealing post and pressurized, and fluid is introduced via the actuator body, the chamber's fluidic oscillator inlet is in fluid communication with a first power nozzle and second power nozzle. The first power nozzle is configured to accelerate the movement of passing pressurized fluid flowing through the first nozzle to form a first jet of fluid flowing into the chamber's interaction region, and the second power nozzle is configured to accelerate the movement of passing pressurized fluid flowing through said second nozzle to form a second jet of fluid flowing into said chamber's interaction region. The first and second jets impinge upon one another at a selected inter-jet impingement angle and generate oscillating flow vortices within said fluid channel's interaction region.

The present invention may be configured as a kit having a spray head similar to those shown in FIG. 1 or 13, and further including one or more of the reconfigured spray heads and a plurality of different inserts including an array of fluidic circuit modular components with varying configurations for varying 2-D (e.g. fan-shaped) or 3-D (e.g., rectangular, oval or circular area-shaped shaped) sprays. For each of the fluidic circuit modular components (e.g., 152, 372 or 422) the assembled nozzle assembly's chamber is configured so that when the fluidic circuit modular component is fitted to abutment with or fluid communication with the body's sealing post and pressurized fluid is introduced via the actuator body, the fluidic circuit modular components interaction region is in fluid communication with the discharge orifice defined in the fluidic circuit's distal wall, and the oscillating flow vortices exhaust from the discharge orifice as a distally projecting oscillating spray of substantially uniform fluid droplets in a selected spray pattern having a selected spray width and a selected spray thickness and the nozzle cap may be rotated about the sealing post axis by the user to rotate the orientation of the resulting spray.

When the user or consumer wants to assemble or reconfigure and use the modular nozzle assembly of the present invention, the user locates the distally projecting sealing post (e.g., 64) centered within the spray head's body locates the snap-fit peripheral detent wall groove configured to resiliently receive and retain the removable spray cap member (e.g., 150) which is automatically axially aligned with the spray head when press-fit into place. The user may then rotate the removable spray cap member (e.g., 150) about the spray head axis to orient the spray pattern (e.g., vertical, with the spray's major axis aligned vertically and parallel to the product packages major axis). Once installed, the removable spray cap member (e.g., 150) encloses and seals the fluidic circuit oscillator inlet in fluid communication with spray head and a test spray can be performed to demonstrate that when pressurized fluid is introduced into the nozzle assembly, the pressurized fluid enters the fluidic's interaction chamber and generates at least one oscillating flow vortex which is aligned to provide a desired spray.

In alternative configurations, the ‘swapped’ or user reconfigurable geometry described above may also be packaged for OEM product vendors at the point of manufacturing—prior to trigger sprayer assembly. Alternative configurations with increased inlet or feed channel size leading into the fluidic/nozzle would facilitate a lower trigger effort. Alternative designs can combine one of the sprayer configurations with alternative spray modes built-in to the spray cap modular member 250, so that a multimode (oscillating droplet generating spray, stream, off) function.

The modular plates, modular cups and offset plates all may be configured for use with rotating spray cap modular members to adjustable spray orientations. Users will most likely prefer either a vertical or horizontal spray pattern for controlled dispensing of the fluid. If the product to be sprayed is typically available in a generic trigger sprayer and can be used for multiple types of fluids then the end user would enjoy having the ability to change from a mist nozzle for Air Care products, to a single inlet fluidic spray (e.g., 152) for a spray with fewer fine particles to inhale. An OEM product vendor may also choose to provide an offset plate fluidic (e.g., 252) for packaging space or to provide a foaming nozzle option for the user. The modular configuration and method of the present invention also enables a large OEM the ability to use a common a trigger sprayer platform for multiple brands/products with little added investment. This is an important economic advantage because the OEM can create a common package look or brand image across multiple products but yet still have functionally different spray outputs.

Having described and illustrated preferred embodiments of a new and improved modular nozzle assembly, it is believed that other modifications, variations and changes will be suggested to those skilled in the art in view of the teachings set forth herein. It is therefore to be understood that all such variations, modifications and changes are believed to fall within the scope of the present invention as defined by the following claims.

We claim:

1. A modular nozzle assembly configured to releasably receive a user selectable and user changeable oscillating spray generating component for selectively creating precise 2-D or 3-D spray patterns of a liquid product, comprising:
(a) spray head including a lumen or duct for dispensing or spraying a pumped or pressurized liquid product or fluid from a valve, pump or actuator assembly; said spray head having a distally projecting sealing post with a post peripheral wall terminating at a distal or outer face, said spray head including a fluid passage communicating with said lumen;
(b) a spray cap modular member configured for removable attachment with said spray head, said spray cap modular member having a peripheral wall extending proximally and outwardly of said sealing post and having a distal radial wall comprising an inner face opposing said sealing post's distal or outer face to define a fluid channel between said sealing post and said distal wall;
(c) a fluidic circuit modular component having an inner face with features defined therein and configured to engage said distal wall of said spray cap modular member;
(d) said fluidic circuit modular component inner face having surfaces forming a fluidic circuit oscillation inducing geometry with a fluidic channel including a chamber when said fluidic circuit modular component is fitted to the spray cap distal wall;
(e) said fluidic circuit modular component inner face being configured to define a fluidic circuit oscillator having an interaction region in fluid communication with said spray cap's chamber when said fluidic circuit modular component is fitted to said spray cap and when said spray cap is fitted to said spray head's sealing post and pressurized fluid is introduced via said spray head, whereby pressurized fluid entering said fluid channel chamber and interaction region generates at least one oscillating flow vortex within said interaction region; and
(f) wherein said fluidic circuit modular component member's distal wall includes a discharge orifice in fluid communication with said interaction region.

2. The modular nozzle assembly of claim 1, wherein said fluidic circuit modular component incorporates a first power nozzle and second power nozzle, said first power nozzle being configured to accelerate the movement of passing pressurized fluid flowing through said first power nozzle to form a first jet of fluid flowing into said interaction region, and said second power nozzle being configured to accelerate the movement of passing pressurized fluid flowing through said second power nozzle to form a second jet of fluid flowing into said interaction region so that when said spray cap modular member carrying said fluidic circuit modular component is fitted to the spray head's sealing post and pressurized fluid is introduced, said first and second jets impinge upon one another at a selected inter-jet impingement angle and generate oscillating flow vortices within said interaction region.

3. The modular nozzle assembly of claim 2, wherein said chamber is configured so that when said pressurized fluid is introduced via said spray cap modular member, said chamber's interaction region is in fluid communication with said discharge orifice defined in said fluidic circuit modular component's distal wall, and said oscillating flow vortices exhaust from said discharge orifice as an oscillating spray of substantially uniform fluid droplets in a selected spray pattern having a selected spray width along a selected spray width axis and a selected spray thickness, and wherein said spray head is rotatable about said sealing post to permit the user to rotate said spray width axis.

4. The modular nozzle assembly of claim 3, wherein said selected inter-jet impingement angle is 180 degrees and said oscillating flow vortices are generated within said interaction region by opposing jets.

5. The modular nozzle assembly of claim 5, wherein said fluidic circuit modular component's power nozzles and interaction region are molded directly into said fluidic circuit modular component's interior wall and the fluidic circuit is thus configured to be economically fitted onto the spray cap modular member.

6. The modular nozzle assembly of claim 5, wherein said fluidic circuit modular component is configured as a disc or plate shaped member having a circular periphery;
said fluidic circuit modular component's interior surface having a first latching tab projecting proximally away from said interior surface near said periphery, said first latching tab having a beveled head defining an angled surface which tapers outwardly from a proximal tip to a barb-like retaining edge which faces said fluidic circuit modular component's circular periphery;
said fluidic circuit modular component's interior surface also having a second latching tab spaced apart from said first latching tab and projecting proximally away from said interior surface near said periphery, said second latching tab having a beveled head defining an angled surface which tapers outwardly from a proximal tip to a barb-like retaining edge which faces said fluidic circuit modular component's circular periphery;
said first and second latching tabs being configured to engage first and second corresponding slots configured within the distal exterior surface of said spray cap modular member.

7. The modular nozzle assembly of claim 3, wherein said spray head's distally projecting sealing post, said spray cap modular member and said fluidic circuit modular component member's discharge orifice are all coaxially aligned along a single spray axis.

8. The modular nozzle assembly of claim 3, wherein said spray head's distally projecting sealing post has a first distally projecting axis and said fluidic circuit modular component member's discharge orifice is configured to spray along a second axis which is parallel to but spaced from said sealing post axis in an offset spray configuration.

9. A modular nozzle assembly configured to releasably receive a user selectable and user changeable oscillating spray generating component for selectively creating precise 2-D or 3-D spray patterns of a liquid product, comprising:
(a) spray head including a lumen or duct for dispensing or spraying a pumped or pressurized liquid product or fluid from a valve, pump or actuator assembly; said spray head having a distally projecting sealing post with a post peripheral wall terminating at a distal or outer face, said spray head including a fluid passage communicating with said lumen;
(b) a spray cap modular member configured for removable attachment with said spray head, said spray cap modular member having a peripheral wall extending proximally and outwardly of said sealing post and having a distal radial wall comprising an inner face opposing said sealing post's distal or outer face to define a fluid channel between said sealing post and said distal wall;
(c) a disc-shaped or cup-shaped fluidic circuit modular component or carrier having an inner face with features defined therein and configured to receive said sealing post's distal face;
(d) said fluidic circuit modular component inner face having surfaces forming a fluid channel including a fluidic chamber when said fluidic circuit modular component is fitted to the sealing post's distal face;
(e) said fluidic circuit modular component's inner face being configured to define a fluidic circuit oscillator having an interaction region in said fluidic chamber when said fluidic circuit modular component is fitted to said sealing post and pressurized fluid is introduced via said actuator body, the pressurized fluid entering said fluidic channel chamber and interaction region to generate at least one oscillating flow vortex within said interaction region; and
(e) wherein said fluidic circuit modular component's distal wall includes a discharge orifice in fluid communication with said interaction region.

10. The modular nozzle assembly of claim 9, wherein said fluidic circuit oscillator incorporates a first power nozzle and second power nozzle, said first power nozzle being configured to accelerate the movement of passing pressurized fluid flowing through said first nozzle to form a first jet of fluid flowing into said interaction region, and said second power nozzle being configured to accelerate the movement of passing pressurized fluid flowing through said second nozzle to form a second jet of fluid flowing into said interaction region so that when said fluidic circuit modular component is fitted to the body's sealing post and pressurized fluid is introduced via said actuator body, said first and second jets impinge upon one another at a selected inter-jet impingement angle and generate oscillating flow vortices within said interaction region.

11. The modular nozzle assembly of claim 10, wherein said chamber is configured so that when said fluidic circuit modular component is fitted to the body's sealing post and pressurized fluid is introduced via said actuator body, said chamber's interaction region is in fluid communication with said discharge orifice defined in said fluidic circuit's distal wall, and said oscillating flow vortices exhaust from said discharge orifice as an oscillating spray of substantially uniform fluid droplets in a selected spray pattern having a selected spray width and a selected spray thickness.

12. The modular nozzle assembly of claim 11, wherein said fluidic circuit modular component is releasably secured within said spray head, whereby other modular components carrying different fluidic circuits are selectably and interchangeably securable to said spray head.

13. The modular nozzle assembly of claim 11, wherein said selected inter-jet impingement angle is 180 degrees and said oscillating flow vortices are generated within said interaction region by opposing jets.

14. The modular nozzle assembly of claim 9, wherein said fluidic circuit modular component's power nozzles and interaction region are molded directly into said fluidic circuit modular component's interior wall and the fluidic circuit is thus configured to be economically fitted onto the spray cap modular member.

15. A fluidic circuit modular component for easy and economical incorporation into a modular trigger spray nozzle assembly for an aerosol spray head actuator body including a distally projecting sealing post and a lumen for dispensing or spraying a pressurized liquid product or fluid from a transportable container to generate an exhaust flow in the form of an oscillating spray of fluid droplets, comprising;
(a) a disc-shaped or cup-shaped fluidic circuit having an inner face with fluid guiding features defined therein and configured to be mounted in said modular component;
(b) said fluidic circuit inner face having surfaces forming a fluid channel including a chamber when said fluidic circuit modular component is fitted to the spray head actuator sealing post;
(c) said inner face being configured to define a fluidic circuit oscillator having an interaction region in fluid communication with said chamber when said fluidic circuit modular component is fitted to said nozzle assembly sealing post and pressurized fluid is introduced via said actuator body, the pressurized fluid entering said fluid channel chamber and interaction region to generate at least one oscillating flow vortex within said interaction region;
(d) wherein said fluidic circuit includes a discharge orifice in fluid communication with said interaction region; and
(e) wherein said modular component is releasably secured to a spray head actuator body incorporating an actuator sealing post, whereby modular components carrying different fluidic circuits are selectably and interchangeably securable to said spray head.

16. The fluidic circuit modular component of claim 15, wherein said fluidic circuit oscillator incorporates a first power nozzle and second power nozzle, said first power nozzle being configured to accelerate the movement of passing pressurized fluid flowing through said first nozzle to form a first jet of fluid flowing into said interaction region, and said second power nozzle being configured to accelerate the movement of passing pressurized fluid flowing through said second nozzle to form a second jet of fluid flowing into said interaction region so that when said fluidic circuit modular component is fitted to the body's sealing post and pressurized fluid is introduced via said actuator body, said first and second jets impinge upon one another at a selected inter-jet impingement angle and generate oscillating flow vortices within said interaction region.

17. The modular nozzle assembly of claim 16, wherein said selected inter-jet impingement angle is 180 degrees and said oscillating flow vortices are generated within said interaction region by opposing jets.

18. The modular nozzle assembly of claim 15, wherein said fluidic circuit modular component's power nozzles and interaction region are molded directly into said fluidic circuit modular component's interior wall and the fluidic circuit is thus configured to be economically fitted onto the spray cap modular member.

19. A method for assembling a modular nozzle assembly for spraying or dispensing a liquid product, material or fluid, comprising:
(a) providing a spray head including a lumen or duct for dispensing or spraying a pumped or pressurized liquid product or fluid from a valve, pump or actuator assembly; said spray head having a distally projecting sealing post with a post peripheral wall terminating at a distal or outer face, said spray head including a fluid passage communicating with said lumen;
(b) providing a spray cap modular member configured for removable attachment with said spray head, said spray cap modular member having a peripheral wall extending proximally and outwardly of said sealing post and having a distal radial wall comprising an inner face opposing said sealing post's distal or outer face to define a fluid channel between said sealing post and said distal wall;
(c) selecting a fluidic circuit modular component having an inner face with features defined therein and configured to engage said distal wall of said spray cap modular member, wherein said fluidic circuit modular component inner face having surfaces forming a fluidic circuit oscillation inducing geometry with a fluidic channel including a chamber when said fluidic circuit modular component is fitted to the spray cap distal wall; said fluidic circuit modular component inner face being configured to define a fluidic circuit oscillator having an interaction region in fluid communication with said spray cap's chamber when said fluidic circuit modular component is fitted to said spray cap and when said spray cap is fitted to said spray head's sealing post and pressurized fluid is introduced via said spray head, whereby pressurized fluid entering said fluid channel chamber and interaction region generates at least one oscillating flow vortex within said interaction region; and wherein said fluidic circuit modular component member's distal wall includes a discharge orifice in fluid communication with said interaction region
(d) engaging said fluidic circuit modular component with said distal wall of said spray cap modular member and releasably affixing said fluidic circuit modular component into fluid tight or sealing engagement with said spray cap modular member.

20. The method for assembling a modular nozzle assembly of claim 17, further comprising: rotating said takes the removable spray cap member on said sealing post about the central axis of said sealing post to provide a selected angular orientation for sprayed fluid.
